(19) United States
(12) Patent Application Publication
(10) Pub. No.: US 2012/0079558 A1
(43) Pub. Date: Mar. 29, 2012

(54) Safety and securely us personal computer working at home or anywhere instead of going and working in the office

(75) Inventor: Qiuhang Qian, Doraville, GA (US)

(73) Assignee: Qiuhang Richard Qian, Doraville, GA (US)

(21) Appl. No.: 12/924,378

(22) Filed: Sep. 27, 2010

(51) Int. Cl. G06F 21/00

(52) U.S. Cl. 726/1

(57) ABSTRACT

Revolutionary safely and securely using computers work at home or on the road is invented. The architecture of Corpnetlk7 built for the platform includes components, utility programs and files majority residing on the host company's servers. They work together with local and corporate machines where configurations are made and certain programs are installed. The user will go through different steps before reaching to the corporate legacy system. Corpnetlk7 consists of Corpnetlk7 Client, Server and Corporate Side Configuration Utility, Corpnetlk7 Connection Agent, Corpnetlk7 Names Server Manager, Corpnetlk7 Enterprise App, Corpnetlk7 User App, Corpnetlk7 Security Enhancement Layers, Corpnetlk7 Programs Repository, Corpnetlk7 Programs Security Storage Lockroom, Corpnetlk7 Multithreaded Server, Corpnetlk7 Host GUI Interface and Corpnetlk7 New User Checksum etc. The user creates connectivity on the local machine and Corpnetlk7 helps the user resolve the names service.

It is known that an employee can use lap or desk top to work in a company's intranet environment after it is configured. An employee uses Internet Protocol technologies to securely share any part of an organization's information or network. He or she can work anywhere at home or on the road.

A new way of safely and securely using personal computer working at home or on the road instead of working in the office is created. With this solution, every employee of an organization is eligible for working at home or somewhere else where there is an interne connection. So employees don't need to go to the office if there is emergency; if they need to finish or catch up on work; if they would like to reduce commuting time or expense; if they want to coordinate work schedule with personal or family needs; if they don't feel good; if they are on the road, on vacation or for any other reasons. On the other hand the working at home platform provides maximum security for using computers working at home.

### TECHNICAL FIELD

The present invention relates to network systems that are capable of running and support services and programs both on the client's local machine, the corporate and the host company's server(s). More particularly, the present invention relates to the network systems that enable people to work at home instead of going and working in the office. The client local machine refers to the personal computer that an end user (employee) uses. The host company refers to the business that provides the working at home services both to the companies, corporations and the employees.

### BACKGROUND OF THE INVENTION

Working at home has become more and more popular in recent years. In fact, the United States Department of Labor believes that by the year 2025 up to two-thirds of all Americans could be working from home.

In May 2004, the Bureau of Labor issued a statistic report indicating that 20.7 million persons usually did some work at home as part of their primary job. These workers, who reported working at home at least once per week, accounted for about 15 percent of total nonagricultural employment. Another report issued in March 2009 by the U.S. Department of Labor showed about 12 percent of full-time workers with a single job did some work at home on an average day in 2003-07.

The most common reason to work at home through survey was “finish or catch up on work” (56 percent). An additional 32 per-cent reported that they worked at home at least once per week because it was the “nature of the job.” Other reasons to work at home were: coordinating work schedule with personal or family needs; reducing commuting time or expense; local transportation or pollution control program. Among the people who worked at home, over 80% used computer as part of their work and 70 percent used the Internet or e-mail. The report also showed there were many people working while traveling on the road or even on vacation.

### BRIEF DESCRIPTION OF THE DRAWINGS

FIG. 1 is a functional diagram block illustrating how technically using personal computer working at home is safely and securely built.

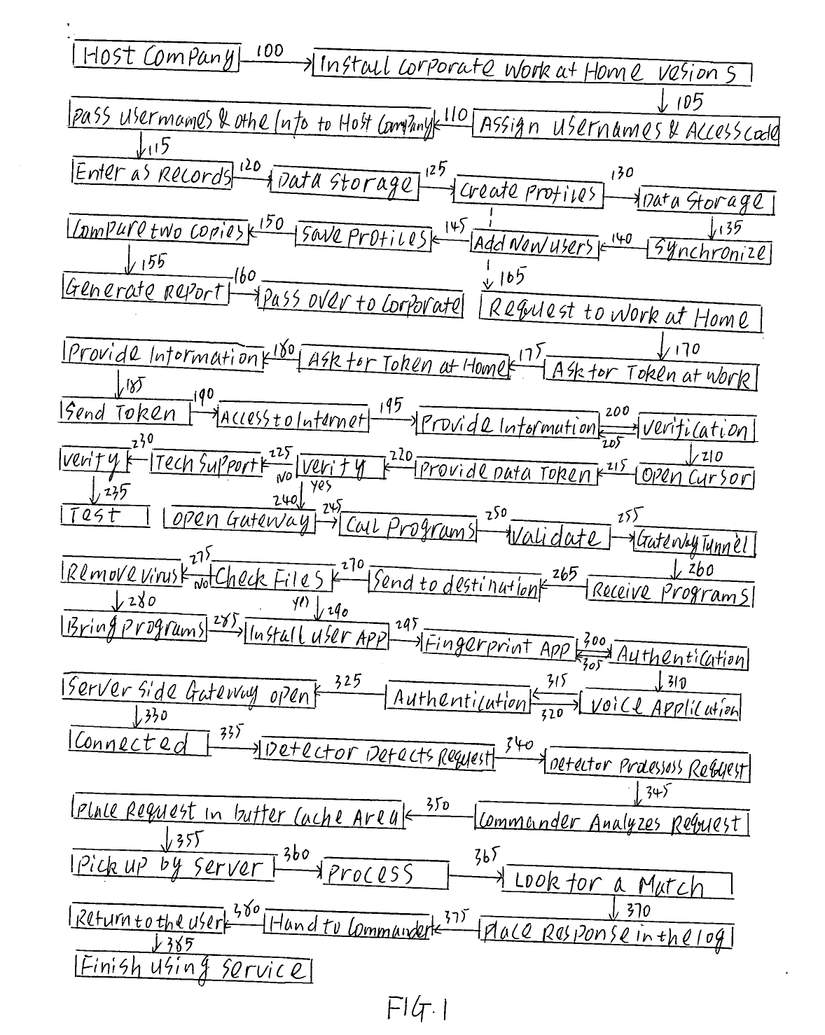

### DETAILED DESCRIPTION OF EXEMPLARY EMBODIMENTS

The present invention provides a solution for people to work at home safely and securely using their computers instead of going and working in the office. Although the preferred embodiment will be generally described in the context of a program and an operating system running on a client computer, those skilled in the art will recognize that the present invention also can be implemented in conjunction with other program modules on other types of computers. Furthermore, those skilled in the art will recognize that the present invention can be implemented in different network environments.

For example, in a two-tier network, a user communicates directly with a server. This is also known as client-server architecture. A client-server network is an architecture that involves user processes that request service from server processes. The user and the server communicate over a network using a given protocol, which must be installed on both the user and the server. In an N-tier architecture, the role of the middle-tier agent can be manifold. It can provide: translation services (as in adapting a legacy application on a mainframe to a user-server environment or acting as a bridge between protocols); scalability services (as in acting as a transaction-processing monitor to balance the load, of requests between servers); intelligent agent services (as in mapping a request to a number of different servers, collating the results, and returning a single response to a user). In a complex network environment, different hardware platforms run different operating systems; multiple protocols are used on these platforms; variable syntax exist between the different but connected applications; run on different geographical locations in which the connected applications reside. It supports a large-scale distributed system.

In a distributed computing environment, program modules may be physically located in different local and remote memory storage devices. Execution of the program modules many occur locally in a stand-alone manner or remotely in a user server manner. Examples of such distributed computing environments include local area networks of an office, enterprise-wide computer networks and the global internet.

The detailed description which follows is represented largely in terms of processes and symbolic representations of operations by conventional computer components, including a central processing unit (CPU), memory storage devices for the CPU, display devices, and input devices. Furthermore, these processes and operations may utilize conventional computer components in a heterogeneous distributed computing environment, including remote file servers, remote computer servers, and remote memory storage devices. Each of these conventional distributed computing components is accessible by the CPU via a communication network.

The processes and operations performed by the computer include the manipulation of signals by a CPU or remote server and the maintenance of these signals within data structures resident in one or more of the local or remote memory storage devices.

For the purpose of this discussion, a process is generally conceived to be a sequence of computer-executed steps leading to a desired result. These steps usually require physical manipulation of physical quantities. Usually, though not necessarily, these quantities take the form of electrical, magnetic, or optical signals capable of being stored, transferred, combined, compared, or otherwise manipulated. It is convention for those skilled in the art to refer to representation of these signals as bits, bytes, words, information, elements, symbols, characters, numbers, points, data, entries, objects, images, files, or the like. It should be kept in mind, however, that these and similar terms are associated with appropriate physical quantities for computer operations, and that these terms are merely conventional labels applied to physical quantities that exist within and during operation of the computer

It should be understood that manipulations within the computer are often referred to in terms such as creating, adding, changing, modifying, saving, calculating, comparing, moving, receiving, determining, identifying, populating, loading, executing, etc. that are often associated with manual operations performed by a human operator. The operations described herein can be machine operations performed in conjunction with various input provided by a human operator or user that interacts with the computer.

In addition, it should be understood that the programs, processes, methods, etc. described herein are not related or limited to any particular computer or apparatus. Rather various types of general purpose machines may be used with the program modules constructed in accordance with the teachings described herein. Similarly, it may prove advantageous to construct a specialized apparatus to perform the method steps described herein by the way of dedicated computer systems in specific network architecture with hardwired logic or programs stored in nonvolatile memory, such as ready-only memory. Such data structures impose a physical organization upon the collection of data stored within a memory storage device and represent specific electrical or magnetic elements. These symbolic representations are the means used by those skilled in the art of computer programming and computer construction to most effectively convey teachings and discoveries to other skilled in the art.

The business model is built and established based on the service agreement between the host company and the businesses. The host company is the company that provides the services to the businesses. The businesses refer to any business including companies and corporations big, medium or small in the U.S. The service agreement lists all the clauses, terms and options. The signed agreement is the final contract that both parties agree on each clause, term and option. The establishment and execution of the service agreement will experience the stages of contacting, discussing, gathering information, reaching agreement, setting up an account; implementing and monitoring. Instructions, manuals and technical support will be provided during the service period.

Corpnetlk7 is the core product. It includes components like Corpnetlk7 Client, Server and Corporate Side Configuration Utility, Corpnetlk7 Connection Agent, Corpnetlk7 Names Server Manager, Corpnetlk7 Corporate Application, Corpnetlk7 User Application, Corpnetlk7 Security Enhancement Layers, Corpnetlk7 Programs Repository, Corpnetlk7 Programs Security Storage Lockroom, Corpnetlk7 Multithreaded Server, Corpnetlk7 Host GUI Interface and Corpnetlk7 New User Checksum etc. Corpnetlk7 provides the industry's broadest support for network transport protocols, including TCP/IP, Novell SPX/IPX, IBM LU6.2, and DECnet. All the data conversion using Corpnetlk7 is invisible to the user and the applications. This enable Corpnetlk7 to operate across different types of computers, operating systems, and network to transparently connect any combination of PC, UNIX, legacy, and other systems without changes to the existing infrastructure.

Corpnetlk7 contains configuration and administration mechanisms that are designed for complicated environments. Corpnetlk7 Connection Agent is a tool configured and installed on the middle tier. It offers multi-logging and cross-protocol connections. Corpnetlk7 Names Server is a distributed name service, where all the corporation addresses are stored in the network environment. Corpnetlk7 adopts network security using encryption and enhancement layers. With Corpnetlk7 Multithreaded Server, Corpnetpk7 communicates and sends many service process requests to share a few server processes. It enables to reduce the number of process requests against one web browser instance resolution; achieve load balancing, reduce the idle server processes, and memory usages and system overhead. Corpnetlk7 Names Server Manager stores connect information in the database files and in a local data cache. It addresses from internet connectivity to the intranet and corporation legacy systems in the network environment through integration of standard solutions such as HTTP (Hypertext Transfer Protocol), IIOP (Internet Inter-ORB Protocol), RADIUS, and LDAP. Through the connectivity and using the protocols, the clients can use the application from within network environment. Refers now to the drawing:

Two corporate versions of working at home are installed on the corporate server (Step 100). One is for the employees and the other is for the employer. The employee's version has the capabilities of communicating between the employees both working at the office and at home in the format of online texting, email, and video chatting. It has other functions like creating profile, company identity, fingerprint and voice enrollment, establishing email account with the host company and requesting to work at home etc. Creating a profile, having an email account, fingerprint and voice enrollment are for network connection and security purposes. The employer's version will have other functions such as log statistics checking, which can include the history of the people who work at home either by monthly, quarterly or annually; their registration status in the history by monthly, quarterly or annually; and current online status when the employee works at home etc.

The next step is the step that the clients (employees) are informed of the company's access code and the user names to log into the host company's website (Step 105). These employees' user names along with the department and other required values are passed over to the host company (Step 110) and be entered as records in the form (Step 115). The information is stored in the database on Server A (Step 120). The value of the department will be associated with the privilege using the corporate legacy system. The email will be used to verify the identity when the client requests to use the host company's service.

The employees are asked to create profiles (Step 125). Their profiles are stored in the profile database on the corporate server (Step 130). The host company has the same copy stored on Server B as the corporate (Step 135). Both copies synchronize. Any new added users' information passed from the company will be added on server A (Step 140) and the profiles created by the clients will be stored on Server B (Step 145). The Corpnetlk7 New User Checksum will check the accuracy of the total users who are in the network by comparing both copies on both servers (Step 150). It will generate checksum report (Step 155) and pass it over the corporation (Step 160). The Corpnetlk7 New User Checksum carries out the task and communicates with the corporation. The Corpnetlk7 New User Checksum is one of the security mechanisms that eliminates the unauthorized users or correct the actual users in the network.

Step 165 is the step the client requests to work at home (Besides getting approved from the manager). If the client is at the work place, the client sends an email to the host company asking for an access data token (Step 170); If the client is at home, the client logs onto the host company's front page asking for a data token (Step 175). The client provides the security information before the data token is sent to the client (Step 180). The security information includes corporate access code, user name and email address. The token is sent to the client through email (Step 185). The client accesses to the interne (Step 190). The client provides the company access code and username (Step 195). The process verifies the data with the data on the server (Step 200). If the data is not valid, the process goes back and asks for the valid data until the data is good (Step 205). If the data is valid, the cursor opens (Step 210). The client provides the data token for verification (Step 215 and 220). The one-time data token is another security enhancement device designed to prevent from attacking and penetrating into the corporate legacy system. The date tokens are pre-defined and stored in the secured data files on the server. They are randomly assigned to the client through the gateway tunnel and can be valid for only one time.

If the data token is not valid, the client needs to contact the technical support to get another token (Step 225). The client has to provide confidential information before having another one (Step 230). The technical support checks the accessibility of the old token before issuing another one (Step 235). If the data token is good, the communication gateway opens (Step 240) and a server process initiates a call for program A, B, C and D in the programs repository (Step 245). The Programs Repository has all the programs to support programs and applications running both on the local machine, the host company and the corporate servers. The Corpnetlk7 Programs Security Storage Lockroom stores the programs that are called to update and validate the codes in the Programs Repository regularly with advanced security approach. It requires higher security mechanism to access, verify and initiate processes to perform various functions.

Program A, B, C and D validate and update with the programs in the security storage lockroom on the Programs Security Storage Lockroom server (Step 250) and takes the path back through the gateway tunnel to the local client receiver (Step 255). The local client receiver receives the procedure programs and sends them to the destination (Step 260 and 265).

The programs check the OS and other files and are updated to the current (Step 270). The programs check the integrity of the local system as well as check the spyware, screen scraping and other types of virus. The virus will be removed if found (Step 275). The valid version, files patches are brought from the Programs Repository (Step 280). And the user application will be installed after the system is up to the current (Step 285). If the system is good and up to the current, the client user application will be installed and put on the desktop on the local machine (Step 290). The application provides user oriented activities such as character and graphical user interface display, screen navigation and control, data presentation, application flow and other application specifics including online communication between the employees and the company, fingerprint and voice pattern enrollment etc. The company has the choice to install a screen scraping program on the client's local based on the service agreement.

After the client user application is installed, two application programs will be invoked. They are pattern recognition programs which automatic identify the user by determining the authenticity of a specific anatomical or behavioral characteristic possessed by the user. The first application is about biometrics fingerprint (Step 295). It is activated to enhance security and reduce fraud and used for real-time recognition. The user uses two thumbs to match the fingerprints stored on the host company's server (Step 300). If the fingerprint is not matched, the user is asked to enroll again (Step 305). If the fingerprint is matched, the voice pattern application is invoked (Step 310). The user speaks to the microphone (Step 315). If the voice pattern doesn't match, the user is asked to enroll again (Step 320). If the voice pattern matches, the gateway opens on the server side (Step 325). The user can make enrollment anytime through the applications both at home, work or on the host company's web page.

The Connection Agent adapts the request through protocol after the string is connected (Step 330). The Connect Agent is a multipurpose, networking solution for Corpnetlk7 that provides greater resource utilization for increased scalability, multiprotocol connectivity, and secure network access control. It can be set up to filter connections based on origin and destination, and support multiprotocol connection such as APPC, DECnet, Named Pipes, SPX/IPX and TCP/IP. The Connect Agent is installed on the middle tier level. The connection process and names server process need to be configured. The connection process includes the listing detector address for the Connection Agent as well as the destination receiver. For the address specified for the Connection Agent, both the node on the Agent and the port number are specified. For the address of the receiver at the destination node, both port and the node names are specified. And the parameter for the service names for the corporate is configured positive like yes. Other parameters such as CCA_Start, CCA_Stop, and CCA_Status etc are configured.

The detector detects and processes the coming service request (Step 335 and 340). The commander receives and analyzes the request (Step 345). The commander places the request in the system buffer cache area (Step 350). A shared server picks up the request and processes it (Step 355 and 360). During the process the server goes to the database to look for a match (Step 365). The shared server places the response on the calling commander's response log (Step 370). The response is handed off to the commander (Step 375). The commander returns the response back to the user (Step 380). The response refers to whether the connection succeeds or fails.

The process is a typical process taking place in the Corpnetlk7 Multithreaded Server Network environment. And it is combined with using Corpnetlk7 Names Server Manager configured for the service resolution purpose. In the Corpnetlk7 Multithreaded Server Network, server processes are share among user processes. The user still can request a dedicated server. It increases the number of possible users; achieves loading balance etc. Corpnetlk7 Multithreaded Server Network configuration enable shared servers, dedicated servers and combined users and servers to in the same network environment.

The Corpnetlk7 detector and commander files are configured and done through by Corpnetlk7 Server-Side Configuration Utility (CSSCU). Files can be created, added, edit and deleted etc. The parameters will be decided and determined. These parameters include name, address, connection time, name service, wait time, directory, trace file location and log file status etc.

The Corpnetlk7 Names Server Manager (CNSM) provides name service resolution of the corporate in the network. It uses centralized naming method and resolves a service name the client request by translating the service name to a connect string. Under the centralized naming method, hierarchical domains are adopted under the root. The characteristics are: enable distribution of network administration responsibilities; maintains a domains hierarchical structure under the top centralized domain root; contains unique service names for each domain. Steps to configure the central naming service includes opening CNSM, creating name for the name server, attaching a domain, setting the protocol, entering the node name on which the names server reside and the port at which accepts the incoming resolution request. The process ends when the employee finishes using the service (Step 385).

1. Safely and securely use personal computer working at home or anywhere instead of going and working in the office.
